(19) United States
(12) Patent Application Publication
(10) Pub. No.: US 2025/0238282 A1
(43) Pub. Date: Jul. 24, 2025

(54) DETERMINISTIC NETWORK ARCHITECTURE AND WORKING METHOD FOR INTELLIGENT APPLICATIONS

(71) Applicant: BEIJING JIAOTONG UNIVERSITY, Beijing (CN)

(72) Inventors: Weiting ZHANG, Beijing (CN); Dong YANG, Beijing (CN); Hongke ZHANG, Beijing (CN); Nian TANG, Beijing (CN); Tong SUN, Beijing (CN); Jiadong REN, Beijing (CN); Ruibin GUO, Beijing (CN)

(21) Appl. No.: 18/893,567

(22) Filed: Sep. 23, 2024

(30) Foreign Application Priority Data
Jan. 18, 2024 (CN) 202410069439.3

(51) Int. Cl. G06F 9/50; G06F 9/48

(52) U.S. Cl. CPC G06F 9/5083; G06F 9/4881

(57) ABSTRACT

Deterministic network architecture and working method for intelligent applications are provided. Generalized service layer obtains task parameters of computing task generated by large model of intelligent application during training, deployment, or inference stage. Mapping adaptation layer determines resource orchestration scheme based on task parameters and determines transmission scheduling scheme based on resource orchestration scheme. Resource orchestration scheme includes target computing domain for completing computing task, and computing resources, storage resources, and communication resources allocated to computing task from target computing domain. Transmission scheduling scheme includes time slots and communication resources for transmitting computing task to target computing domain. Converged network layer transmits computing task to target computing domain based on transmission scheduling scheme. This architecture converges communication resources with computing resources to support co-scheduling of large models, and synchronously designs resource orchestration scheme and transmission scheduling scheme, to prevent transmission scheduling complications caused by new data traffic.

### CROSS REFERENCE TO RELATED APPLICATION

This patent application claims the benefit and priority of Chinese Patent Application No. 202410069439.3 filed with the China National Intellectual Property Administration on Jan. 18, 2024, the disclosure of which is incorporated by reference herein in its entirety as part of the present application.

### TECHNICAL FIELD

The present disclosure relates to the technical field of communication networks, in particular to a deterministic network architecture and working method for intelligent applications.

### BACKGROUND ART

At present, intelligent applications (also known as artificial intelligence (AI) applications) demonstrate significant advantages across various fields. A large AI model (also known as a large model) are crucial components supporting the operation of intelligent applications. For instance, the large model utilizes deep learning technology to accurately comprehend and processes human languages, images, and videos; the large model extracts personalized information by analyzing massive data, and providing field-independent customized services to users; and the large model enables comprehensive network monitoring and management, thereby enhancing network reliability, and fault detection and prediction capabilities.

However, the large model faces numerous challenges in widespread deployment and application in wireless networks, due to their distinctive characteristics. Firstly, construction of the large model generally consists of three stages: training, deployment, and inference. Each stage requires both communication and computing resources to facilitate co-scheduling for the large model. Secondly, the large model generates various data traffics at different stages. To avoid model performance degradation caused by discontinuous and inconsistent data traffic transmission of the large model, deterministic transmission should be considered at each stage of the large model. Although time-sensitive networking (TSN) and deterministic networking (DetNet) can achieve deterministic data transmission with bounded delay, jitter, and packet loss guaranteed, new data traffic complicates transmission scheduling.

In response to these challenges, there is an urgent need to design a network architecture that integrates communication and computation to support emerging large models in future wireless networks.

### SUMMARY

The purpose of the present discourse is to provide a deterministic network architecture and working method for intelligent applications. This architecture converges communication resources with computing resources to support co-scheduling of large models, and synchronously designs a resource orchestration scheme and a transmission scheduling scheme, to prevent transmission scheduling complications caused by new data traffic.

To achieve the above objective, the present disclosure provides the following technical solutions.

A deterministic network architecture for intelligent applications includes: a generalized service layer configured to obtain task parameters of a computing task generated by a large model of an intelligent application during a training stage, a deployment stage, or an inference stage, where the task parameters include a data volume, a transmission speed, transmission time, computing resource requirement, and communication resource requirement; a mapping adaptation layer configured to determine a resource orchestration scheme based on the task parameters and determine a transmission scheduling scheme based on the resource orchestration scheme, where the resource orchestration scheme includes a target computing domain for completing the computing task, and computing resources, storage resources, and communication resources allocated to the computing task from the target computing domain, and the transmission scheduling scheme includes time slots and communication resources for transmitting the computing task to the target computing domain; and a converged network layer configured to transmit the computing task to the target computing domain based on the transmission scheduling scheme.

In some embodiments, the generalized service layer includes one computing server (CS) and a plurality of domain servers (DSs) to complete distributed training of the large model; the CS is configured to receive updated model parameters from each DS, to obtain global model parameters; and each DS is configured to receive the global model parameters and locally train the large model to obtain the updated model parameters.

In some embodiments, the mapping adaptation layer includes a plurality of domain service controller (DSCs) and one computing service controller (CSC), and each DSC corresponds to one computing domain; the DSC is configured to obtain resource parameters of the computing domain and determine a resource scheme based on the task parameters and the resource parameters of the computing domain; the resource parameters include the computing resources, storage resources, and communication resources; the resource scheme includes whether the computing domain is used to complete the computing task, and the computing resources, storage resources, and communication resources allocated to the computing task from the computing domain; and all resource schemes form the resource orchestration scheme; and the CSC is configured to obtain communication resources of the converged network layer and determine the transmission scheduling scheme based on the resource orchestration scheme and the communication resources of the converged network layer.

In some embodiments, a Multi-agent Proximal Policy Optimization (MAPPO)-based resource orchestration algorithm is deployed on the DSC; and a Dueling Deep Double Q-Network (D3QN)-based end-to-end transmission scheduling algorithm is deployed on the CSC.

In some embodiments, the converged network layer includes TSN and 5G DetNet that are connected in sequence; and a time-aware shaper (TAS), a cyclic queuing and forwarding (CQF), or a credit-based shaper (CBS) is deployed in a TSN switch or a 5G DetNet router.

A working method of the above deterministic network architecture for intelligent applications includes: obtaining, by a generalized service layer configured to obtain task parameters of a computing task generated by a large model service layer, task parameters of a computing task generated by a large model of an intelligent application during a training stage, a deployment stage, or an inference stage, where the task parameters include a data volume, a transmission speed, transmission time, computing resource requirement, and communication resource requirement; determining, by a mapping adaptation layer, a resource orchestration scheme based on the task parameters, and determining a transmission scheduling scheme based on the resource orchestration scheme, where the resource orchestration scheme includes a target computing domain for completing the computing task, and computing resources, storage resources, and communication resources allocated to the computing task from the target computing domain, and the transmission scheduling scheme includes time slots and communication resources for transmitting the computing task to the target computing domain; and transmitting, by a converged network layer, the computing task to the target computing domain based on the transmission scheduling scheme.

In some embodiments, said determining, by the mapping adaptation layer, the resource orchestration scheme based on the task parameters, and determining the transmission scheduling scheme based on the resource orchestration scheme specifically includes: obtaining, by each DSC of the mapping adaptation layer, resource parameters of a computing domain, and determining a resource scheme by using an MAPPO-based resource orchestration algorithm with the task parameters and the resource parameters of the computing domain as input, where the resource parameters include the computing resources, storage resources, and communication resources; the resource scheme includes whether the computing domain is used to complete the computing task, and the computing resources, storage resources, and communication resources allocated to the computing task from the computing domain; and all resource schemes form the resource orchestration scheme; and obtaining, by a CSC of the mapping adaptation layer, communication resources of the converged network layer, and determining the transmission scheduling scheme by using a D3QN-based end-to-end transmission scheduling algorithm with the resource orchestration scheme and the communication resources of the converged network layer as input.

In some embodiments, determining the resource scheme by using the MAPPO-based resource orchestration algorithm with the task parameters and the resource parameters of the computing domain as input specifically includes: generating a first state information based on the task parameters and the resource parameters of the computing domain, where the first state information includes an acceptable delay and the computing resource requirement of the computing task, and the resource parameters of the computing domain; and determining the resource scheme based on the first state information.

In some embodiments, determining the transmission scheduling scheme by using the D3QN-based end-to-end transmission scheduling algorithm with the resource orchestration scheme and the communication resources of the converged network layer as input specifically includes: generating a second state information based on the resource orchestration scheme and the communication resources of the converged network layer, where the second state information includes a source address, a destination address, and the acceptable delay of the computing task, a TSN link capacity, and a 5G link capacity; and determining the transmission scheduling scheme based on the second state information.

According to the embodiments of the present disclosure, the following technical effects are disclosed: the present disclosure discloses a deterministic network architecture and working method for intelligent applications. The deterministic network architecture includes: a generalized service layer configured to obtain task parameters of a computing task generated by a large model of an intelligent application during a training stage, a deployment stage, or an inference stage, where the task parameters include a data volume, a transmission speed, transmission time, computing resource requirement, and communication resource requirement; a mapping adaptation layer configured to determine a resource orchestration scheme based on the task parameters and determine a transmission scheduling scheme based on the resource orchestration scheme, where the resource orchestration scheme includes a target computing domain for completing the computing task, and computing resources, storage resources, and communication resources allocated to the computing task from the target computing domain, and the transmission scheduling scheme includes time slots and communication resources for transmitting the computing task to the target computing domain; and a converged network layer configured to transmit the computing task to the target computing domain based on the transmission scheduling scheme. This architecture converges communication resources with computing resources to support co-scheduling of large models, and synchronously designs a resource orchestration scheme and a transmission scheduling scheme, to prevent transmission scheduling complications caused by new data traffic.

### BRIEF DESCRIPTION OF THE DRAWINGS

To describe the technical solutions in the embodiments of the present disclosure or in the prior art more clearly, the accompanying drawings required for the embodiments are briefly described below. Apparently, the accompanying drawings in the following description show merely some embodiments of the present disclosure, and those of ordinary skill in the art may still derive other accompanying drawings from these accompanying drawings without inventive efforts.

FIG. 1 is a structural diagram of a deterministic network architecture according Embodiment 1 of the present disclosure;

FIG. 2 is a flowchart of an MAPPO-based resource orchestration algorithm according to Embodiment 1 of the present disclosure;

FIG. 3 is a flowchart of a D3QN-based end-to-end transmission scheduling algorithm according to Embodiment 1 of the present disclosure; and

FIG. 4 is a flowchart of a working method of the deterministic network architecture according Embodiment 2 of the present disclosure.

### DETAILED DESCRIPTION OF THE EMBODIMENTS

The technical solutions of the embodiments of the present disclosure are clearly and completely described below with reference to the drawings in the embodiments of the present disclosure. Apparently, the described embodiments are merely a part rather than all of the embodiments of the present disclosure. Based on the embodiments of the present disclosure, all other embodiments obtained by a person of ordinary skill in the art without inventive efforts shall fall within the protection scope of the present disclosure.

The purpose of the present discourse is to provide a deterministic network architecture and working method for intelligent applications. This architecture converges communication resources with computing resources to support co-scheduling of large models, and synchronously designs a resource orchestration scheme and a transmission scheduling scheme, to prevent transmission scheduling complications caused by new data traffic.

In order to make the above objective, features and advantages of the present disclosure clearer and more comprehensible, the present disclosure will be further described in detail below in combination with accompanying drawings and particular implementations.

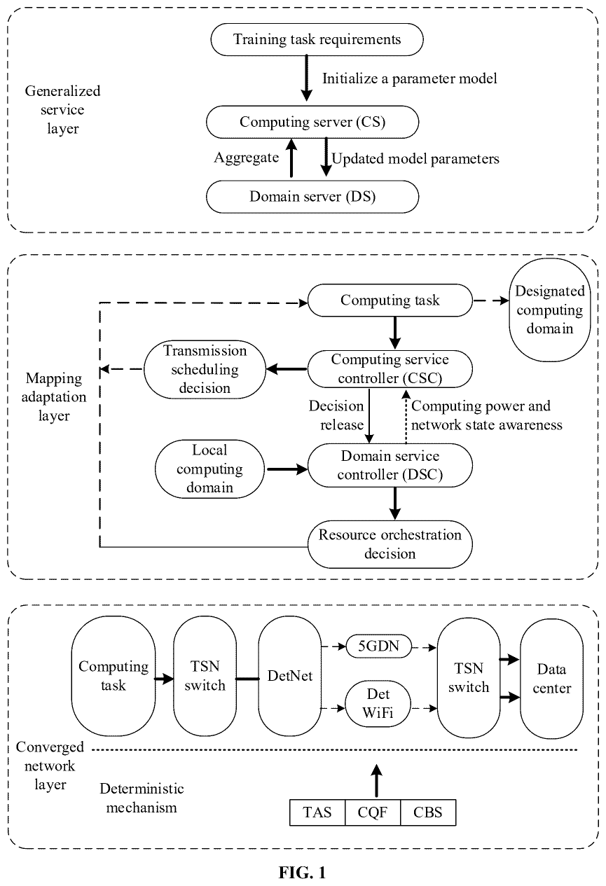

Embodiment 1: This embodiment provides a deterministic network architecture for intelligent applications. As shown in FIG. 1, the architecture includes a generalized service layer 1, a mapping adaptation layer 2, and a converged network layer 3.

The generalized service layer 1 is configured to obtain task parameters of a computing task 21 generated by a large model of an intelligent application during a training stage, a deployment stage, or an inference stage. The task parameters include a data volume, a transmission speed, transmission time, a computing resource requirement, and a communication resource requirement.

The mapping adaptation layer 2 is configured to determine a resource orchestration scheme based on the task parameters, and determine a transmission scheduling scheme based on the resource orchestration scheme. The resource orchestration scheme includes a target computing domain for completing the computing task 21, and computing resources, storage resources, and communication resources allocated to the computing task 21 from the target computing domain; and the transmission scheduling scheme includes time slots and communication resources for transmitting the computing task 21 to the target computing domain.

The converged network layer 3 is configured to transmit the computing task 21 to the target computing domain based on the transmission scheduling scheme.

In this embodiment, the large model may be a large AI model. Training, deployment, and inference of the large model are all completed on the generalized service layer 1. In the process of training, deployment, and inference of the large model, many computing tasks 21 are generated. For example, in the training stage, the large model processes an input parameter to obtain an output value, which will generate a computing task 21; and model parameters of the large model are updated based on the output value and a true value, which will generate a computing task 21; in the deployment stage, the large model is loaded into a production environment to package the large model into a binary text file, which will generate a computing task 21; initialization of the large model involves reading the model parameters from a storage medium and loading the model parameters into a memory, which will generate a computing task 21; in the inference stage, the trained large model processes an input parameter to obtain a predicted value, which will generate a computing task 21. All the computing tasks 21 generated in the above three stages need to be transmitted, through the deterministic network architecture in this embodiment, to the target computing domain for processing.

In this embodiment, the generalized service layer 1 is configured to implement the description and expression of the computing tasks 21 generated by the large model in the training, deployment, and inference stages. Specifically, after the large model generates a computing task 21 in the training, deployment, or inference stage, the generalized service layer 1 describes the generated computing task 21 to express the generated computing task 21 for obtaining the task parameters of the generated computing task 21. Resource orchestration and transmission scheduling are subsequently performed based on the task parameters, and the generated computing task 21 is transmitted to the target computing domain. The computing tasks 21 generated in the training, deployment, and inference stages of the large model are model parameter transmission tasks, and all the computing tasks 21 can be described and expressed using the data volume, transmission speed, transmission time, and costs of the model parameters. The data volume includes dimensionality and total bytes of data, the transmission speed is the number of bytes or bits transmitted per second, the transmission time is a ratio of the data volume to the transmission speed, and the costs include network costs and bandwidth costs. The network costs indicate the computing resource requirement (i. e., the number of computing resources needed to complete the computing task 21), and the bandwidth costs indicate the communication resource requirement (i. e., the number of communication resources needed to transmit the computing task 21). Therefore, the task parameters for each computing task 21 include the data volume, the transmission speed, the transmission time, the computing resource requirement, and the communication resource requirement. Based on this, the scale, requirements, and costs of the computing task 21 can be accurately obtained for corresponding resource orchestration and transmission scheduling.

Specifically, one computing server (CS) 11 and a plurality of domain servers (DSs) 12 are deployed on the generalized service layer 1, to support efficient distributed training of the large model. To be specific, the generalized service layer 1 in this embodiment includes one CS 11 and a plurality of DSs 12 to complete distributed training of the large model; the CS 11 is configured to receive updated model parameters from each DS 12, to obtain global model parameters; and the DS 12 is configured to receive the global model parameters and locally train the large model to obtain the updated model parameters. More specifically, in the training process, the CS 11 and the DS 12 work iteratively. In the first iteration, the CS 11 initializes the model parameters according to training task requirements 10 of the large model, to obtain the global model parameters. The DS 12 obtains the global model parameters from the CS 11, performs local training on the large model, and further updates the model parameters of the large model, to obtain the updated model parameters. In a subsequent iteration, the CS 11 aggregates the updated model parameters from each of the distributed DSs 12, determines the global model parameters based on the updated model parameters from all the DSs 12, and updates the global model parameters by setting weights. Specifically, a weight is set for the updated model parameters from each DS 12, and weighted summation is performed on the updated model parameters from all the DSs 12 according to the weights, to obtain the global model parameters. The DS 12 obtains the global model parameters from the CS 11, performs local training on the large model, and further updates the model parameters of the large model to obtain the updated model parameters until the iteration process is completed. By obtaining these model parameters, after the generalized service layer 1 generates the task parameters of the computing task 21, the mapping adaptation layer 2 can perform corresponding resource orchestration and transmission scheduling.

In this embodiment, the mapping adaptation layer 2 is configured to realize dynamic resource orchestration and transmission scheduling through the convergence of communication and computing, thereby supporting the training, deployment, and inference stages of the large model while meeting the diversified requirements of the computing tasks 21.

Specifically, a plurality of domain service controllers (DSCs) 23 and one computing service controller (CSC) 22 are deployed in the mapping adaptation layer 2. Each DSC 23 corresponds to one computing domain, which can be referred to as the local computing domain 20 of the DSC 23. Based on the quantitative description of the computing task 21, each DSC 23 aggregates resource information from the corresponding local computing domain 20 and executes a resource orchestration decision 24. In addition, the CSC 22 executes a transmission scheduling decision 25, and realizes the collaborative resource management across geographically distributed computing domains, to meet the diversified requirements of the computing tasks 21.

More specifically, the mapping adaptation layer 2 includes a plurality of DSCs 23 and one CSC 22. One DSC 23 corresponds to one computing domain, and the DSC 23 is configured to obtain resource parameters of the corresponding computing domain, and determine a resource scheme based on the task parameters and the resource parameters of the computing domain. The resource parameters include computing resources, storage resources, and communication resources. The resource scheme includes whether the computing domain is used to complete the computing task 21, and computing resources, storage resources, and communication resources allocated to the computing task 21 from the computing domain. Resource schemes determined by all the DSCs 23 form the resource orchestration scheme, and the resource orchestration scheme includes the target computing domain for completing the computing task 21, and the computing resources, the storage resources, and the communication resources allocated to the computing task 21 from the target computing domain. It is noted that, if the resource scheme indicates that the computing domain is used to complete the computing task 21, the computing domain is the target computing domain of the computing task 21. The CSC 22 is configured to obtain communication resources of the converged network layer 3, and determine the transmission scheduling scheme based on the resource orchestration scheme and the communication resources of the converged network layer 3. The transmission scheduling scheme includes time slots and communication resources for transmitting the computing task 21 to the target computing domain.

Preferably, a Multi-agent Proximal Policy Optimization (MAPPO)-based resource orchestration algorithm is deployed on each DSC 23, and the MAPPO-based resource orchestration algorithm is responsible for selecting, at the logical level, a target computing domain according to the characteristics of the computing task 21 (i. e., the task parameters of the computing task 21) and load of the computing domain (i. e., the resource parameters of the computing domain), to support processing of the computing task 21, and provide identification information of the target computing domain (i. e., an IP address of the target computing domain, and the computing resources, storage resources, and communication resources allocated to the computing task 21 from the target computing domain, where the IP address of the target computing domain is an IP address of a target server deployed on the target computing domain). The DSC 23 adopts the MAPPO-based resource orchestration algorithm to determine the resource scheme, with the task parameters and the resource parameters of the computing domain as input, so as to further determine the resource orchestration scheme.

A D3QN (Dueling Double Deep Q-network)-based end-to-end transmission scheduling algorithm is deployed on the CSC 22. The D3QN-based end-to-end transmission scheduling algorithm combines a current link state of the converged network layer 3 (i. e., the communication resources of the converged network layer 3), and determines a transmission path according to the IP address of the target computing domain, to ensure that a data packet deterministically reaches the target computing domain. The CSC 22 adopts the D3QN-based end-to-end transmission scheduling algorithm to determine the transmission scheduling scheme, with the resource orchestration scheme and the communication resources of the converged network layer 3 as input. The D3QN-based end-to-end transmission scheduling algorithm is called to realize intelligent and flexible scheduling of the computing tasks 21 by dynamically controlling the transmission sequence of the computing tasks 21, such that the computing tasks 21 of the large model can meet the deterministic requirements preferentially, thus realizing the low-delay and high-reliability transmission of the computing tasks 21.

After the resource orchestration scheme and the transmission scheduling scheme have been determined, the relevant information of the computing task 21 (i. e., data of the computing task 21, the task parameters of the computing task 21, and the identification information of the target computing domain) is packaged into a data packet and transmitted over the network to the target computing domain. The target computing domain receives the data packet and executes the computing task 21, and the execution result is turned back to a task initiator through the same network path.

In this embodiment, the converged network layer 3 provides a stable and deterministic network environment for the whole deterministic network architecture, and the converged network layer 3 is used to deterministically transmit the computing task 21 to the designated target computing domain according to the resource orchestration scheme and the transmission scheduling scheme of the mapping adaptation layer 2, so as to meet the service requirements of bounded delay, jitter, and packet loss.

Specifically, the converged network layer 3 in this embodiment adopts a converged network architecture combining time-sensitive networking (TSN), deterministic networking (DetNet), and 5G technologies, to support wireless and wired deterministic transmission. The above-mentioned converged network layer 3 is used to realize deterministic transmission of the computing task 21. The computing task 21 is first transmitted over a local area network, and transmitted to the DetNet 32 through a TSN switch 31, which involves wired transmission (using a router for forwarding). The computing task 21 may be far away from the data center 33 (i. e., a set of computing domains). In this case, the computing task 21 needs to be transmitted from the DetNet 32 to a base station, and then transmitted to the data center 33 by the base station, which involves wireless transmission, thus realizing wireless and wired deterministic transmission. The TSN can ensure that all devices in the local area network send and receive data packets according to the same scheduling list, thus ensuring that the transmission delay of the data packets is predictable. The DetNet 32 allows specific resources (e.g., bandwidth and queues) to be allocated to critical traffic (e.g., time-sensitive traffic) in a wide area network, thus reducing delay and improving reliability. By using higher frequency bands, more antennas, and advanced modulation technology, 5G technology provides high bandwidth and large data transmission capacity. The above three technologies are combined to meet the strict requirements of large model services.

In this embodiment, a deterministic transmission mechanism is further deployed in a TSN switch 31 or a DetNet router, and the deterministic transmission mechanism is a time aware shaper (TAS) 351, a cyclic queuing and forwarding (CQF) 352, or a credit-based shaper (CBS) 353. CQF 352 is used to build a transmission queuing model that realizes task priority transmission. CQF 352 consists of a circular timer and two transmission queues, with queue state (open or closed) toggling based on parity time slots. In each time slot, one queue can send a data packet and the other queue can receive the data packet. By adjusting the message queue, the transmission delay of data packets can be controlled.

More specifically, the converged network layer 3 in this embodiment includes the TSN and the 5G DetNet that are connected in sequence. The 5G DetNet means replacing the original frequency bands, antennas, and modulation technology in the DetNet with higher frequency bands, more antennas, and advanced modulation technology of 5G technology. The TAS 351, CQF 352, or CBS 353 is deployed in the TSN switch 31 or 5G DetNet router. The 5G technology is used to provide high bandwidth and large data transmission capacity, to meet the deterministic transmission requirements of computing tasks 21.

However, the large models face numerous challenges in widespread deployment and application in wireless networks, due to their distinctive characteristics. These challenges further include a fact that construction of large model requires the collaboration among edge computing, cloud computing, and in-network computing to support large model services with higher demands on computing resources. In this embodiment, the CS 11 and a plurality of DSs 12 are deployed in the generalized service layer 1. The CS 11 operates in the cloud, representing cloud computing, and the DSs 12 serve as edge servers, embodying as edge computing. As the computing tasks 21 are transmitted and forwarded through the converged network layer 3, a computing-enabled router can be used to process a small computing task 21, which can be considered as in-network computing, thus enabling collaboration among edge computing, cloud computing, and in-network computing.

According to the requirements for each layer of the designed deterministic network architecture, this embodiment provides cross-domain computing resource orchestration and deterministic transmission algorithms based on deep reinforcement learning (DRL), including dynamic resource awareness, the MAPPO-based resource orchestration algorithm, and the D3QN-based end-to-end transmission scheduling algorithm. Dynamic resource awareness is employed to obtain and analyze underlying heterogeneous resource information to achieve perception of communication and computing resources, perceive dynamic changes in the available capacities of the computing and communication resources in complex network environment in real time to ensure that an integrated communication and computing network can obtain accurate resource information, and construct a matching system that facilitates the collaboration between resource orchestration and transmission scheduling, thus completing the process of the DSC 23 acquiring the resource parameters of the computing domain and the CSC 22 acquiring the communication resources of the converged network layer 3. The MAPPO-based resource orchestration algorithm is employed to complete the process of the DSC 23 generating the resource orchestration scheme. The D3QN-based end-to-end transmission scheduling algorithm is employed to complete the process of the CSC 22 generating the transmission scheduling scheme.

Specifically, the dynamic resource awareness includes information acquisition and feature analysis.

Information acquisition: The CSC 22 perceives network resource information in real time from the converged network layer 3, including a link capacity (i.e., link bandwidth). The DSC 23 perceives various resource information in real time from servers deployed across a plurality of computing domains, including the central processing unit (CPU) frequency, network bandwidth, available resources, remaining energy, and utilization price and so on. The CPU frequency represents computing resources, and the network bandwidth represents communication resources. In this embodiment, the CPU frequency is used to indicate the total computing resources of a server. A server may be processing other computing tasks 21, which occupies a portion of the computing resources. Therefore, the available resources are remaining available computing resources of this server. The available resources represent the computing resources. The remaining energy refers to the battery capacity of the server, indicating whether the server is sufficient to support the next computing task 21. The utilization price refers to the deployment costs of the server.

Feature analysis: The CSC 22 extracts resource features (such as CPU or GPU) from the perceived network resource information through long-term statistical feature analysis, obtains the communication resources of the converged network layer 3, and performs real-time monitoring (such as on the state, load, and availability), to update the communication resources of the converged network layer 3. The DSC 23 extracts resource features (such as CPU or GPU) from the perceived resource information through long-term statistical feature analysis, obtains resource parameters of the computing domain, and performs real-time monitoring (such as on the state, load, and availability), to update the resource parameters of the computing domain. The feature analysis is the prior art, which will not be repeated herein in detail.

The MAPPO-based resource orchestration algorithm is deployed in the DSC 23. The DSC 23 uses the MAPPO-based resource orchestration algorithm to select the optimal resource supply according to dynamic matching between resource characteristics and task requirements, formulates and implements resource orchestration, so as to make automatic decisions and generate the resource scheme. In addition, through continuous learning, resource orchestration ability is gradually improved and resource allocation efficiency is optimized for continuous optimization. Specifically, the MAPPO-based resource orchestration algorithm includes that: a learning agent is deployed in each DSC 23, and a plurality of learning agents jointly perceive the resource state of the current network environment; the globally optimal resource orchestration scheme is obtained through iterative interaction among the learning agents; the resource orchestration scheme is optimized through iterative interaction among the learning agents in a way of collaborative learning; the learning agents share decision information with each other, and regularly share and aggregate the global information to understand the decisions and resource schemes of other learning agents. Through multiple iterations, the learning agent gradually adjusts its local policy in an attempt to achieve the global optimal resource orchestration. Each learning agent observes the current resource state, allocates multidimensional resources to the corresponding computing task 21, obtains a resource scheme through participant decision, such as which computing domain should be scheduled to and how many resources are used in the computing domain, executes the resource scheme to process the computing task 21, and obtains a reward based on the overall resource utilization rate. The resource scheme with more reasonable utilization of distributed computing resources can earn a higher reward, and the reward is used to update the network parameters of the learning agents, thereby realizing optimization.

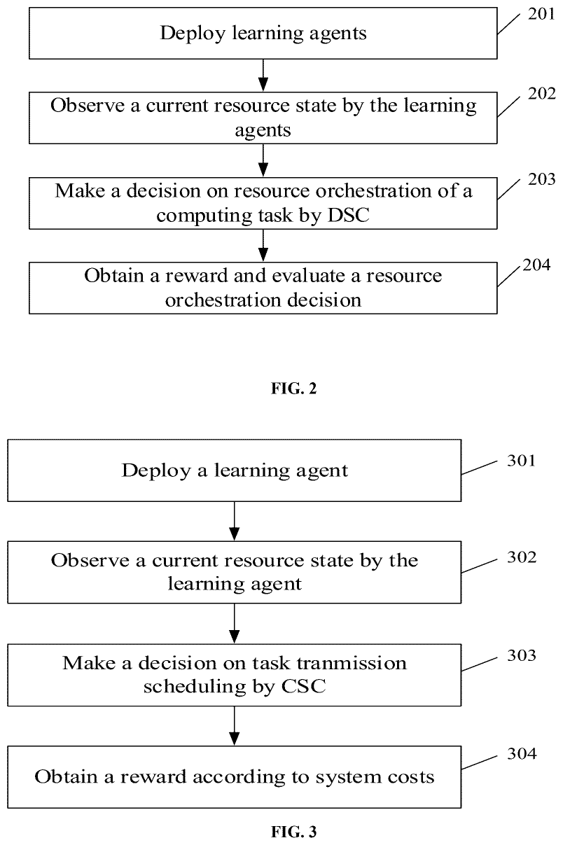

More specifically, as shown in FIG. 2, the MAPPO-based resource orchestration algorithm includes the following steps.

(201) Deploying the learning agent.

One learning agent is deployed in each DSC 23 to perceive the resource state of the current network environment.

(202) Observing the current resource state by the learning agent.

The learning agent learns the environmental state composed of aggregated information of the DSC 23 by observing the current resource state. A multi-agent learning framework is adopted, in which each DSC 23 can be regarded as a single agent. The current resource state can be defined as S={sₘ [symbol] , and Sₘ={cₘ, oₘ, bₘ, tᵢ, eᵢ [symbol] is the state information perceived by DSCₘ, i.e., the first state information. [symbol] is a set of all DSCs 23, cₘ, oₘ, and bₘ respectively represent the computing resources, storage resources, and communication resources of an m^{th} computing domain (i.e., a computing domain corresponding to the m^{th} DSC), and tᵢ and eᵢ respectively represent the acceptable delay and required computing resources (such as the number of processor cores) of an i^{th} computing task 21. The time delay information of the computing task 21 is pre-configured through a flow table, and I is a set of all computing tasks 21.

(203) Making a decision on the resource orchestration of the computing task 21 by DSC 23.

The decision is defined as A={(a_{m,i}, d_{m,i})}_{∀m∈} [symbol] _{,∀i∈I′} a_{m,i}∈[a_{1,i}, . . . , a_{m,i}] represents a scheduling decision of DSCₘ, i.e., whether to schedule the computing task 21 to the computing domain m. d_{m,i}={p_{m,i}, g_{m,i}, n_{m,i}} represents a resource allocation decision. a_{m,i} and d_{m,i} are resource schemes of DSCₘ, and p_{m,i}, g_{m,i}, and n_{m,i} respectively represent the computing resources, storage resources, and communication resources allocated to the computing task i from the computing domain m.

(204) Obtaining the reward and evaluating the resource orchestration scheme.

The learning agents get the reward from the integrated network environment and individually evaluate their resource orchestration schemes in a specific state. In this embodiment, a reward function is used to guide DSCₘ to calculate optimization of the resource scheme, aiming at maximizing the overall resource utilization rate of the computing domain. The reward function is defined as r=Σₘ rₘ, and rₘ=∥ū∥₂−∥ū−uₘ∥₂, where u and uₘ are a target resource utilization rate and an actual resource utilization rate of the m^{th} computing domain. The target resource utilization rate is artificially set, and the actual resource utilization rate is the resources needed/available for computing tasks 21, specified as

$${u}_{m} = \frac{{p}_{m , i}}{{c}_{m}} + \frac{{g}_{m , i}}{{o}_{m}} + \frac{{n}_{m , i}}{{b}_{m}} .$$

The D3QN-based end-to-end transmission scheduling algorithm is deployed in the CSC 22. The CSC 22 uses the D3QN-based end-to-end transmission scheduling algorithm to select the optimal resource supply according to dynamic matching between resource characteristics and task requirements, formulates and executes the transmission scheduling scheme for automatic decision-making. In addition, through continuous learning, the resource scheduling ability is gradually improved and resource allocation efficiency is optimized for continuous optimization. Specifically, the D3QN-based end-to-end transmission scheduling algorithm includes that: the learning agents are deployed in the CSC 22 by adopting a centralized learning architecture, and the learning agents perceive states of the TSN switch 31 and communication link resources in a DetNet environment, and obtains the source address and destination address of the computing task 21 to make a task transmission scheduling decision (such as CQF queue selection and spectrum resource allocation), and obtains a reward based on the system costs. The transmission scheduling scheme that meets deterministic requirements such as time delay, jitter and packet loss earns a higher reward, and the reward is used to update the network parameters of the learning agents, thereby realizing optimization.

More specifically, as shown in FIG. 3, the D3QN-based end-to-end transmission scheduling algorithm includes the following steps.

(301) Deploying the learning agent.

The learning agents are deployed in the CSC 22 by using the centralized learning architecture, to perceive states of the TSN switch 31 and communication link resources in the DetNet environment. (302) Observing the current network state by the learning agent.

The current network state can be defined as S={sₖ} [symbol] , where Sₖ={C_{TSN}, C_{5G}, Fᵢ^{s}, Fᵢ^{d}, Tᵢ}_{∀i∈I} is the state information perceived by the CSC 22 in a time slot k, i.e., the second state information. [symbol] is a set of the time slots, C_{TSN} is the TSN link capacity, C_{5G} is the 5G link capacity, and F₌ᵢ^{s}, Fᵢ^{d}, and Tᵢ respectively represent the source address, destination address, and acceptable delay of the i^{th} computing task.

(303) Making a decision on task transmission scheduling by CSC 22.

The decisions of the CSC 22 on deterministic transmission scheduling and path optimization of the computing task 21 can be defined as A={(q_{k,i}, b_{k,i})} [symbol] , where q_{k,i} ∈{0, 1} is the queue state of CQF. If q_{k,i}=0, the first CQF queue is closed in the time slot k, that is, transmission is stopped; otherwise, q_{k,i}=1. b_{k,i}∈[bₘᵢₙ, bₘₐₓ] is the amount of 5G spectrum resources allocated for the current time slot, and bₘᵢₙ and bₘₐₓ are lower and upper bounds of the amount of 5G spectrum resources respectively.

(304) Obtaining the reward according to the system costs.

The reward function guides the policy optimization of deterministic transmission scheduling in the CSC 22, and the reward function is defined as r=Σₖrₖ, where rₖ=μ_{S}D−μ_{b}B, D is the packet size, B is the bandwidth resource occupied by retransmission, and μₛ and up are respectively the weight factors. D and B can be determined in the data packet transmission, and the data packet size is in the packet header.

This embodiment discloses a deterministic network architecture for intelligent applications, which is an arithmetic network convergence architecture, including a new network architecture for intelligent applications, and the resource orchestration and deterministic transmission scheduling algorithms based on DRL. On the basis of quantitative description of computing tasks, different computing tasks generated by the large model in the three stages are transmitted to the corresponding target computing domains, by resource orchestration and transmission scheduling via appropriate transmission paths, for processing, effectively supporting large model services across life cycles while ensuring bounded delay, jitter, and packet loss.

Based on the concept of communication and computing convergence, a new network architecture for intelligent applications is proposed to support the low-delay requirements of large model services. The architecture includes three layers: the generalized service layer 1, the mapping adaptation layer 2, and the converged network layer 3, which cooperate with each other to realize large model parameter transmission, network and computing mapping, and transmission scheduling in deterministic communication. To be specific, the new network architecture for intelligent applications includes: the generalized service layer 1, the mapping adaptation layer 2, and the converged network layer 3. The generalized service layer 1 describes and expresses the computing task 21 generated by the large model in the training, deployment, or inference stages. The mapping adaptation layer 2 converges communication and computing to realize dynamic resource orchestration and transmission scheduling. According to the resource orchestration and transmission scheduling policies of the mapping adaptation layer 2, the converged network layer 3 deterministically transmits the computing task 21 to the designated computing domain 26, to meet the service requirements of bounded delay, jitter, and packet loss. The above new network architecture for intelligent applications enables each function of each layer to possess independent or collaborative deterministic guarantee capabilities. Through requirement transfer and information sharing among the generalized service layer 1, the mapping adaptation layer 2, and the converged network layer 3, the collaborative effect of communication and computing is fully utilized. This enhances computational efficiency, reduces the transmission delay, and achieves unified management and collaborative scheduling of computing resources within and outside the network. Consequently, this promotes the construction and application of large AI models.

The resource orchestration and deterministic transmission scheduling algorithms based on DRL include: dynamic resource awareness, the MAPPO-based resource orchestration algorithm, and the D3QN-based end-to-end transmission scheduling algorithm. The cross-domain computing resource orchestration and deterministic transmission algorithms based on DRL provided in this embodiment serve the above three-layer network architecture. The cross-domain computing resource orchestration algorithm addresses the resource orchestration challenges across various stages of the large model. Through distributed learning and strategic cooperation among agents, the allocation of computing resources in the computing domains can be dynamically optimized according to the requirements of different stages, thus ensuring efficient operation of training, deployment, and inference. The deterministic transmission scheduling algorithm achieves efficient transmission scheduling for time-sensitive and critical data processing tasks, and ensures low-delay and high-reliability transmission of computing tasks.

The new network architecture and resource orchestration and deterministic transmission scheduling algorithms provided in this embodiment enhance the computing efficiency, reduce the transmission delay, achieve the unified management and collaborative scheduling of computing resources within and outside the network, effectively facilitating the construction and application of large models.

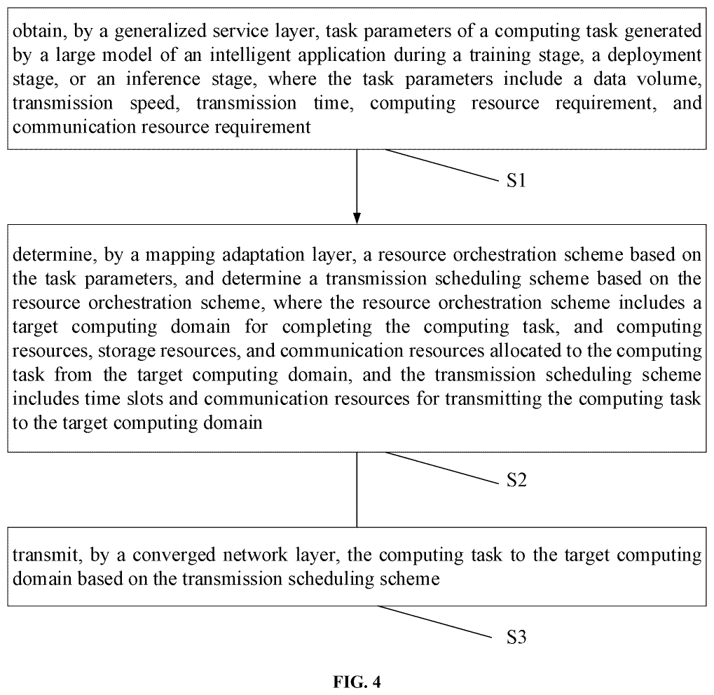

Embodiment 2: This embodiment provides a working method of the deterministic network architecture for intelligent applications according to Embodiment 1. As shown in FIG. 4, the method includes the following steps:

S1: A generalized service layer obtains task parameters of a computing task generated by a large model of an intelligent application during a training stage, a deployment stage, or an inference stage. The task parameters include a data volume, a transmission speed, transmission time, a computing resource requirement, and a communication resource requirement.

S2: A mapping adaptation layer determines a resource orchestration scheme based on the task parameters, and determines a transmission scheduling scheme based on the resource orchestration scheme. The resource orchestration scheme includes a target computing domain for completing the computing task, and computing resources, storage resources, and communication resources allocated to the computing task from the target computing domain, and the transmission scheduling scheme includes time slots and communication resources for transmitting the computing task to the target computing domain.

S3: A converged network layer transmits the computing task to the target computing domain based on the transmission scheduling scheme.

That the mapping adaptation layer determines the resource orchestration scheme based on the task parameters and determines the transmission scheduling scheme based on the resource orchestration scheme specifically includes the following steps:

Each DSC of the mapping adaptation layer obtains resource parameters of a computing domain, and determines a resource scheme by using an MAPPO-based resource orchestration algorithm with the task parameters and the resource parameters of the computing domain as input. The resource parameters include computing resources, storage resources, and communication resources; the resource scheme includes whether the computing domain is used to complete the computing task, and the computing resources, storage resources, and communication resources allocated to the computing task by the computing domain; and the resource schemes determined by all DSCs form the resource orchestration scheme.

A CSC of the mapping adaptation layer obtains communication resources of the converged network layer, and determines the transmission scheduling scheme by using a D3QN-based end-to-end transmission scheduling algorithm with the resource orchestration scheme and the communication resources of the converged network layer as input.

Said determining the resource scheme by using the MAPPO-based resource orchestration algorithm with the task parameters and the resource parameters of the computing domain as input specifically includes the following steps:

First state information is generated based on the task parameters and the resource parameters of the computing domain. The first state information includes an acceptable delay and the computing resource requirement of the computing task, and the resource parameters of the computing domain. The resource scheme is determined based on the first state information.

Said determining the transmission scheduling scheme by using the D3QN-based end-to-end transmission scheduling algorithm with the resource orchestration scheme and the communication resources of the converged network layer as input specifically includes the following steps:

Second state information is generated based on the resource orchestration scheme and the communication resources of the converged network layer. The second state information includes a source address, a destination address, and an acceptable delay of the computing task, a TSN link capacity, and a 5G link capacity.

The transmission scheduling scheme is determined based on the second state information.

Each example of the present specification is described in a progressive manner, each example focuses on the difference with other examples, and the same and similar parts between the examples may be referred with each other.

In this specification, several examples are used for illustration of the principles and implementations of the present disclosure. The description of the foregoing examples is used to help illustrate the method of the present disclosure and the core principles thereof. In addition, those of ordinary skill in the art can make various modifications in terms of specific implementations and scope of application in accordance with the teachings of the present disclosure. In conclusion, the content of the present specification shall not be construed as a limitation to the present disclosure.

The invention claimed is:

1. (canceled)

2. (canceled)

3. A working method of the deterministic network architecture for intelligent applications, comprising:
obtaining, by a generalized service layer, task parameters of a computing task generated by a large model of an intelligent application during a training stage, a deployment stage, or an inference stage, wherein the task parameters comprise a data volume, transmission speed, transmission time, computing resource requirement, and communication resource requirement;
determining, by a mapping adaptation layer, a resource orchestration scheme based on the task parameters, and determining a transmission scheduling scheme based on the resource orchestration scheme, wherein the resource orchestration scheme comprises a target computing domain for completing the computing task, and computing resources, storage resources, and communication resources allocated to the computing task from the target computing domain, and the transmission scheduling scheme comprises time slots and communication resources for transmitting the computing task to the target computing domain;
wherein the mapping adaptation layer comprises a plurality of domain service controllers and a computing service controller; and
transmitting, by a converged network layer, the computing task to the target computing domain based on the transmission scheduling scheme;
wherein determining, by the mapping adaptation layer, the resource orchestration scheme based on the task parameters, and determining the transmission scheduling scheme based on the resource orchestration scheme comprises:
obtaining, by each domain service controller of the mapping adaptation layer, resource parameters of a computing domain, and determining a resource scheme by using an MAPPO-based resource orchestration algorithm with the task parameters and the resource parameters of the computing domain as input, wherein the resource parameters comprise the computing resources, storage resources, and communication resources; the resource scheme comprises whether the computing domain is used to complete the computing task, and the computing resources, the storage resources, and the communication resources allocated to the computing task from the computing domain; and
all resource schemes form the resource orchestration scheme; and
obtaining, by the computing service controller of the mapping adaptation layer, communication resources of the converged network layer, and determining the transmission scheduling scheme by using a D3QN-based end-to-end transmission scheduling algorithm with the resource orchestration scheme and the communication resources of the converged network layer as input;
wherein determining the resource scheme by using the MAPPO-based resource orchestration algorithm with the task parameters and the resource parameters of the computing domain as input comprises:
generating a first state information based on the task parameters and the resource parameters of the computing domain, wherein the first state information comprises an acceptable delay and the computing resource requirement of the computing task, and the resource parameters of the computing domain; and
determining the resource scheme based on the first state information; and
wherein determining the transmission scheduling scheme by using the D3QN-based end-to-end transmission scheduling algorithm with the resource orchestration scheme and the communication resources of the converged network layer as input comprises:
generating a second state information based on the resource orchestration scheme and the communication resources of the converged network layer, wherein the second state information comprises a source address, a destination address, and the acceptable delay of the computing task, a TSN link capacity, and a 5G link capacity; and
determining the transmission scheduling scheme based on the second state information.

4. (canceled)

5. The working method of the deterministic network architecture for intelligent applications according to claim 3, wherein the generalized service layer comprises one computing server and a plurality of domain servers to complete distributed training of the large model;
the computing server is configured to receive updated model parameters from each domain server, to obtain global model parameters; and
the domain server is configured to receive the global model parameters and locally train the large model to obtain the updated model parameters.
